(19) United States
(12) Patent Application Publication
(10) Pub. No.: US 2010/0143669 A1
(43) Pub. Date: Jun. 10, 2010

(54) SUBLIMATION DYE PRINTED TEXTILE DESIGN HAVING METALLIC APPEARANCE AND ARTICLE OF MANUFACTURE THEREOF

(75) Inventor: Louis Brown Abrams, Fort Collins, CO (US)

Correspondence Address: SHERIDAN ROSS PC, 1560 BROADWAY, SUITE 1200, DENVER, CO, 80202, US

(73) Assignee: HIGH VOLTAGE GRAPHICS, INC., Fort Collins, CO (US)

(21) Appl. No.: 12/612,524

(22) Filed: Nov. 4, 2009

Related U.S. Application Data
(60) Provisional application No. 61/120,000, filed on Dec. 4, 2008.

(51) Int. Cl. B32B 3/10

(52) U.S. Cl. 428/196

(57) ABSTRACT

The present invention is directed to an appliqué having dyeable and non-dyeable fibers and a method for making the same.

### CROSS REFERENCE TO RELATED APPLICATIONS

The present application claims the benefit of U.S. Provisional Application No. 61/120,000 filed on Dec. 4, 2008 the entire content of which is incorporated herein by reference in its entirety.

### FIELD OF THE INVENTION

This invention is directed generally to decorative articles, more specifically to decorative articles having a woven graphic design having luster and a method of making the same.

### BACKGROUND OF THE INVENTION

The following text should not be construed as an admission of knowledge in the prior art. Furthermore, citation or identification of any document in this application is not an admission that such document is available as prior art to the present invention, or that any reference forms a part of the common general knowledge in the art.

Appliqués have grown in popularity for a wide variety of applications. In particular, dye-sublimation printed and flocked appliqués. The graphic design of the appliqué is an important aspect of the appliqué. For example, U.S. patent application Ser. No. 12/031,445 discloses an appliqué having a printed image. U.S. patent application Ser. No. 11/874,146 discloses a method of adhesively joining an insert to a flocked appliqué. U.S. patent application Ser. No. 12/031,445, filed Feb. 14, 2008, and Ser. No. 11/874,146 filed Oct. 17, 2007 both to Abrams, the entire content of each is incorporated herein by this reference. More complex, interesting, and unique graphic design features are being sought for artistic and attention grabbing value.

Nothing herein is to be construed as an admission that the present invention is not entitled to antedate a patent, publication or invention by another by virtue of prior invention.

### SUMMARY OF THE INVENTION

It is to be understood that the present invention includes a variety of different versions or embodiments, and this Summary is not meant to be limiting or all-inclusive. This Summary provides some general descriptions of some of the embodiments, but may also include some more specific descriptions of certain embodiments.

In one embodiment, a textile design is provided that includes:
(a) a woven textile having:
   dyeable and non-dyeable fibers, and
   first and second opposing sides; and
(b) an adhesive, wherein the adhesive is positioned on the second side.

In another embodiment, a textile design is provided that includes:
(a) a woven textile having:
   dyeable and non-dyeable fibers, wherein at least some of the dyeable fibers contain at least some dye and wherein at least most, if not all, of the non-dyed fibers substantially lack dye; and
   first and second opposing sides; and
(b) an adhesive, wherein the adhesive is positioned on the second side.

The textile is preferably a woven textile having dyeable and non-dyeable fibers. As used herein, a dyeable fiber means the dyeable fiber is capable of accepting and/or retaining at least some dye within at least some portion of the dyeable fiber. As used herein, a non-dyeable fiber means the non-dyeable fiber substantially lacks the capacity and/or ability to accept and/or retain a dye within at least most, if not all, portions of the non-dyeable fiber. That is, non-dyeable fibers are substantially incapable of accepting and/or retaining a dye within at least most, if not all portions of the non-dyeable fiber. For a modified fiber, the definitions for dyeable and non-dyeable mean the dyeable properties of the modified fiber. For example, a metal-coating applied to a dyeable fiber to substantially block the access of the dye to the dyeable fiber, would be considered a nondyeable fiber.

The dyeability and non-dyeability of a fiber are substantially controlled by the chemical and/or physical properties of the fiber. Dyes are believed to interact and/or bind to chemical polar groups contained within the fiber. Stated another way, fibers having polar groups are more easily dyed than fibers lacking or having a small polar group content. For example, polyolefin fibers substantially lack polar groups, as such, polyolefin fibers are considered to be substantially non-dyeable.

Furthermore, it is more difficult for crystalline regions than amorphous regions of a polymeric fiber to absorb a dye. Therefore, amorphous regions of a fiber are considered by those of skill in the art to be more dyeable than crystalline regions of the fiber. Highly crystalline fibers, such as highly orientated polypropylene fibers, are considered to be substantially non-dyeable.

Metal-coated fibers, which may or may not contain polar groups and/or amorphous regions, are substantially non-dyeable due to the inability of the dye to access the polar groups and/or amorphous regions. The metallic coating substantially forms a barrier which at least physically blocks the polar groups and/or amorphous regions from the dye.

Any dyeing process known within the art can be used to dye the dyeable fibers. In a preferred embodiment, the dying process is a sublimation dying process. Preferred sublimation dyeing processes are described in U.S. Pat. Nos. 7,413,581 and 7,393,576, and U.S. patent application Ser. No. 12/031,445 with a filing date of Feb. 14, 2008, the entire content of each is incorporated herein by this reference in its entirety.

In yet another embodiment, a method includes bonding an adhesive to a first surface of a woven textile to form a woven textile laminate. The first surface is in an opposing relationship with a second surface of the woven textile. Preferably, the second surface has a graphic design image. The woven textile can preferably have dyeable and non-dyeable fibers.

The non-dyeable fibers substantially lack dye. Preferably, after the dyeing of the woven textile, the non-dyebable fibers substantially lack dye and the dyeable fibers contain at least some dye. The non-dyeable fibers can have one or more of a shinny, reflective, and/or sparkly aspect and/or quality. The one or more shinny, specularly and/or sparkly aspect and/or quality of the non-dyeable fibers can be perceived when light impinges the non-dyeable fibers. The shinny, specularly and/or sparkly quality of the non-dyeable fibers substantially accents the textile design and/or the graphic image of the textile design.

In a preferred embodiment, the non-dyeable fibers can be metal fibers, metal-coated fibers, polymeric fibers and/or mixtures thereof. The metal and metal-coated fibers can comprise any metal. In more preferred embodiment, the metal and metal-coated fibers can comprise metal and metal-coated fibers comprising aluminum, stainless steel, indium, tin, silver, gold, chromium, cobalt, nickel, copper, zinc, rhodium, platinum, rhenium, palladium, and combinations thereof.

The polymeric fibers can comprise any polymeric material that can be formed into a fiber. The polymeric material can be a homopolymer, a copolymer and/or a block polymer. The polymeric material can include additives such as, but not limited to, brighteners and/or titanium dioxide. The polymeric material can comprise one or more of the general polymer classes of polyolefins, polystyrenes, polyvinyls, polyacrylics, polyhalo-olefins, polydienes, polyoxides, polyacetals, polysulfides, polyesters, polythioesters, polyamides, polythioamides, polyurethanes, polythiourethanes, polyureas, polythioureas, polyimides, polythioimides, polyanhydrides, polythianhydrides, polycarbonates, polythiocarbonates, polyimines, polysiloxanes, polysilanes, polyphosphazenes, polyketones, polythioketones, polysulfones, polysulfoxides, polysulfonates, polysulfoamides, and polyphylenes. The polymeric fiber can have any shape, such as, but not limited to shapes resembling cylindrical, oval, or trilobal.

In some configurations, the bright, shinny aspects of the fiber comprise one or more of the shape, additives and composition of the non-dyeable fiber. For example, in one configuration the non-dyeable fiber comprises a trilobal fiber. In another example, the non-dyeable fiber contains one or both of a brightener and titanium dioxide.

In a preferred embodiment, the dyeable and non-dyeable fibers comprise at least most, if not all, of the weave of an appliqué and/or a woven textile as described in U.S. application Ser. No. 12/031,445 with a filing date of Feb. 14, 2008, the entire content of which is incorporated hereby this reference in its entirety.

### BRIEF DESCRIPTION OF THE DRAWINGS

FIG. 1 depicts a manufacturing process according to an embodiment;

FIG. 2 is a side view of a textile design according to another embodiment;

FIG. 3 is a plane view of the textile design according to an embodiment;

FIG. 4 is another manufacturing according to another embodiment;

FIGS. 5A and 5B are textile designs according to other embodiments;

FIGS. 6A-G are textile designs according to other embodiments; and

FIG. 7 is a plan view of a textile design according to an embodiment.

### DETAILED DESCRIPTION

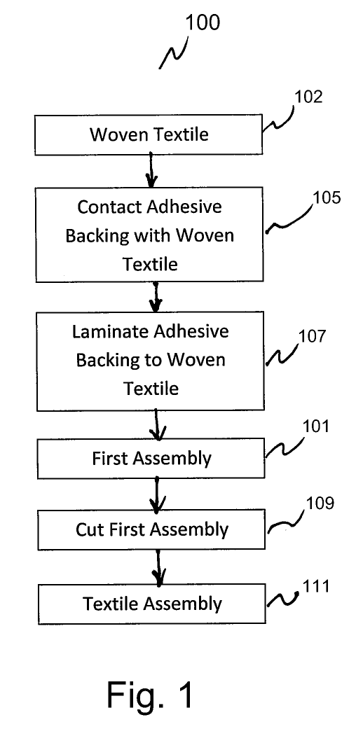

FIG. 1 depicts a method 100 for making a textile design 111. In step 102, a woven textile 103 is provided, the woven textile 103 can be provided with or without a graphic image.

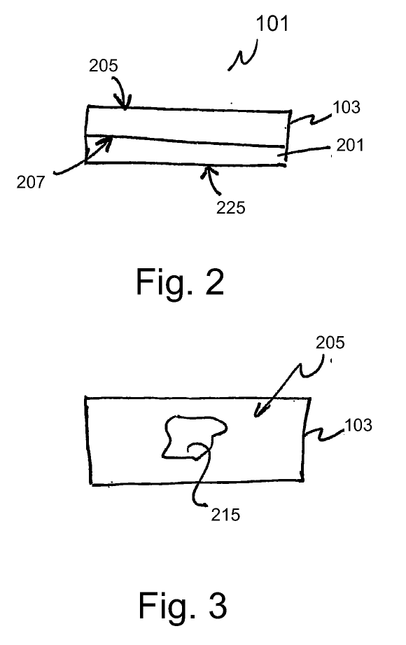

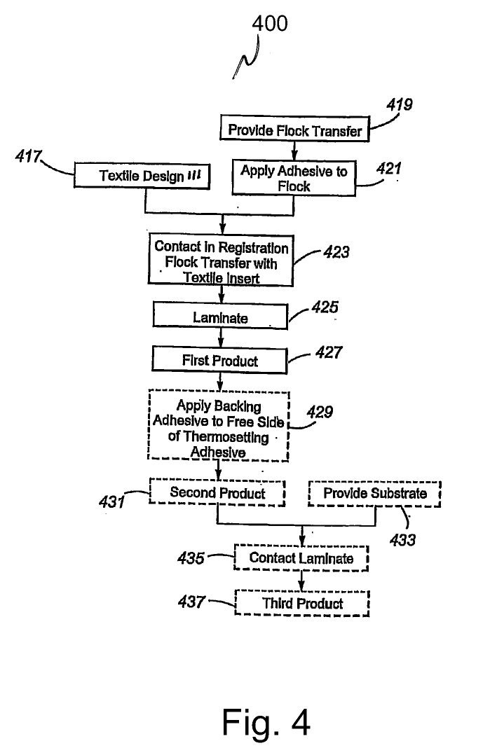

In step 105, an adhesive backing 201 (FIGS. 2 and 3) is contacted with the woven textile 103. In some configurations, the woven insert 111 cam comprise an insert.

The adhesive backing 201 can be any adhesive. Preferably, the adhesive backing 201 is a thermosetting or thermoplastic adhesive. A thermosetting adhesive generally refers to a polymer adhesive that can solidify and/or set irreversibly when heated. The irreversible setting of a thermosetting adhesive is affected by cross-linking of at least most, if not all, of the cross-linking reactive entities contained in the adhesive polymer. A thermoplastic adhesive generally refers to a substantially solid polymeric substance that softens to a plastic state (that is, a deformable state) when heated and returns to the substantially solid state when cooled. Preferably, the adhesive backing 201 can be any adhesive described in U.S. patent application Ser. No. 11/874,146 with a filing date of Oct. 17, 2007 and Ser. No. 12/580,120 with a filing date of Oct. 15, 2009 both to Abrams, the entire content of each is incorporated herein by this reference in its entirety.

The adhesive backing 201 can be a water-based and/or solvent-based adhesive. Furthermore, the adhesive backing 201 can be in the form of a liquid, a solid, a powder and/or a paste. Thermosetting adhesives applied as a liquid and/or in a wet form can be wicked by textile fibers (or yarns) into at least some of the woven textile 103 weave. Preferably, the adhesive backing 201 comprises one of a liquid, solid, powder, paste, or combination/mixture thereof in a dried form. The adhesive backing 201 can comprise, without limitation, one or more of epoxies, phenoformaldehydes, polyvinyl butyrals, cyanoacrylates, polyethylenes, isobutylenes, rubber-based adhesives (styrene copolymers, including without limitation styrene-isoprene-styrene, styrene-butadiene-styrene, and copolymers thereof), silicones, non-crosslinked rubber based latexes, acrylics (acrylics, methacrylates, ethylene ethyl acrylates, ethylene methyl acrylates, and co-polymers thereof), polyurethane, polyamides, polyvinyl acetates, latexes, chloroprenes, butyls, polybutadienes, isoprenes, neoprenes, and polyesters, and can exhibit thermoplastic and/or thermosetting behavior.

The adhesive backing 201 can be supplied as a pre-formed, self-supporting adhesive film. The pre-formed, self-supporting adhesive film can be a thermosetting and/or thermoplastic adhesive. The adhesive film can include polymeric fine particles, as well as optional plasticizer(s), stabilizer(s), pigment(s), etc. Thermosetting adhesives can include curing agents such as organic peroxides, isocyanates or sulfur containing compositions. Examples of thermosetting adhesives include polyethylenes, polyurethanes, polyesters, polyamides, phenolics, alkyds, amino resins, polyesters, epoxides, and silicones. Examples of suitable thermosetting adhesives include, without limitation, polyesters, polyamides, nylons, and mixtures thereof, with a polyester, nylon, or mixtures thereof being preferred.

The adhesive backing 201 can be a dry film thermosetting adhesive, such as, a cast or extruded A-staged thermosetting adhesive film. Thermosetting and thermoplastic adhesives are preferred for their resistances to deterioration during high temperature, high pH industrial laundry processes. In a preferred configuration, the adhesive backing 201 is TSW-20™, a thermosetting adhesive, which can improve the heat-resistance and/or washing (laundry) resistance of the design. In one particular configuration, the washing resistance lasted at least about 100 wash cycles.

The adhesive backing 201 can be a dried paste adhesive. In a preferred embodiment, the dried paste adhesive backing comprises, prior to being dried, a water-based paste adhesive. The water-based paste adhesive comprises water and at least one of a thermosetting adhesive, a thermoplastic adhesive, and/or a combination thereof. In some configurations, after contacting the backing adhesive 201 paste adhesive and the woven textile 103, the paste adhesive is modified by one or more of: i) removing at least some of the liquid from the paste adhesive; ii) heating the paste adhesive; iii) curing at least some of the paste adhesive; iv) thickening the paste adhesive; v) glazing the paste adhesive; and vi) contacting a viscosity modifier with the paste adhesive.

In some configurations, the adhesive backing can comprise a glazing and/or solidifying agent as described in U.S. application Ser. No. 11/413,797 with a filing date of Apr. 28, 2006, Ser. No. 11/565,974, with a filing date of Dec. 1, 2006, and Ser. No. 11/842,387 with a filing date of Aug. 21, 2007, all to Abrams, the entire content of each is incorporated herein by this reference in its entirety.

In some embodiments, the paste adhesive backing 201 is preferably at least partly taken-into the woven textile 103 weave. While the adhesive 380 is at least partly take-into into the woven textile 103 weave, it is preferred that at least some of the adhesive backing 201 extends upward from the woven textile 103 surface. Preferably, the adhesive backing 201 positioned on the woven textile 103 forms a relatively uniform profile of the adhesive backing 201 extending upward from the woven textile 103 surface. More preferably, the adhesive backing 201 forms a relatively uniformly flat profile of the adhesive backing 201 extending upward from the woven textile 103 surface. While not wanting to be bound by theory, the relatively uniform adhesive profile is preferred for subsequent contacting with a flock transfer 300.

The woven textile 103 is a woven textile having a combination of dyeable and non-dyeable fibers. The woven textile 103 can contain any ratio of the non-dyeable to the dyeable fibers. The ratio can vary depending on the design configuration. Preferably, the ratio of non-dyeable to dyeable fibers is no more than about 1:50, more preferably no more than about 1:100 and yet more preferably the ratio is no more than about 1:500. In some design configurations, the ratio of non-dyeable to dyeable fibers is preferably no more than about 1:1,000, more preferably no more than about 1:5,000, and yet more preferably the ratio of non-dyeable to dyeable fibers is no more than about 1:10,000. In other design configurations, the ratio of non-dyeable to dyeable is preferably no more than about 1:1, more preferably no more than about 1:10, and yet more preferably the ratio of non-dyeable to dyeable fiber is no more than about 1:20.

The dyeable fibers can comprise one of natural fibers, synthetic fibers, or mixtures thereof. Non-limiting examples of dyeable fibers are cotton, nylon, polyamide, polyester, rayon, poly(cyclohexylene-dimethylene terephthalate), poly(1,4-cyclohexylene-dimethylene terephthalate), and poly(ethylene terephthalate). The dye can be applied to the fibers by any method known within the art. Sublimation dyeing is a non-limiting example of a dyeing process.

The non-dyeable fibers can comprise one of natural fibers, synthetic fibers, metallic fibers, metallic-coated natural fibers, metallic-coated synthetic fibers, or mixtures thereof. Preferably, the non-dyeable fibers comprise a metalized polyester (such as MYLAR® fibers and/or yarns, MYLAR® comprises a metalized poly(ethylene terephthalate).

The dyeable and non-dyeable fibers can be incorporated into the woven textile 103 by any manner known within the art. In one embodiment, the dyeable and non-dyeable fibers are incorporated into the woven textile 103 weave. Non-limiting examples of suitable woven textile 103 weaves having dyeable and non-dyeable fibers are: jacquard; brocade; bedford, damask; wandering weft; leno; needle or bobbin lace; embroidered, looped or knotted netting; open-work embroidery, knitting, macramé; sprang; wrap-or weft-faced; brocatelle; and slit, dovetailed, interlocking or eccentric tapestry weaves.

In some configurations, the woven textile 103 containing dyeable and non-dyeable fibers can comprise a woven textile 103 having a graphic design contained within the weave of the woven textile 103. Suitable examples of a woven textile 103 containing a graphic design within the weave of the woven textile 103 are described within U.S. patent application Ser. No. 12/397,946 with a filing date of Mar. 4, 2009, which is incorporated in it entirety herein by this reference.

In one embodiment, the dyeable fibers can comprise some or all of the weft fibers and non-dyeable fibers can comprise some or most of the wrap fibers. In another embodiment, the dyeable fibers can comprise some or most of the warp fibers and non-dyeable fibers can comprise some or most of the weft fibers. In yet another embodiment, both the weft and wrap fibers can contain both dyeable and non-dyeable fibers.

As used herein the terms fiber and yarn can be used interchangeability. Fiber typically being a material used to manufacture a fabric. Furthermore, fibers are typically spun into yarn for weaving into a fabric and/or formed into a fabric by a non-woven process.

In another embodiment, at least some non-dyeable yarns are introduced as supplementary (or filler) yarns into the weave of the woven textile 103 comprising dyeable yarns. In still yet another embodiment, at least some non-dyeable yarns are introduced as supplementary (or filler) yarns into the weave of the woven textile 103. In yet another embodiment, one or more of the supplemental, pick, and/or filling yarns of the weave can comprise one or both of the dyeable and/or non-dyeable fibers. Having dyeable and non-dyeable yarns within the weave of the woven textile 103 creates unique beauty and luster in the woven textile 103.

The non-dyeable fibers can be randomly distributed throughout the woven textile 103. In other configurations, the non-dyeable fibers can be distributed more predominately within the graphic image and/or images contained within the woven textile 103. Preferably, the non-dyeable fibers are distributed more predominately within the sublimation printed images within the woven textile 103. In another configuration, the non-dyeable fibers can be distributed more predominately in the woven textile 103 lacking the graphic image and/or images contained within the woven textile 103. In yet another embodiment, the non-dyeable fibers are substantially distributed uniformly throughout the woven textile 103.

The woven textile 103 has first 205 and second 207 opposing surfaces. When the woven textile 103 is provided with a graphic design image 215, the graphic design image 215 is substantially on the first surface 205. In a preferred embodiment, the design image 215 is a sublimation printed image. Preferably, when the graphic design image is substantially on the first surface 205, the adhesive backing 201 is contacted with the second 207 surface.

In step 107, the adhesive backing 201 is laminated to the woven textile 103 to form a first assembly 101. One or both of heat and pressure can be applied during the lamination process. In one embodiment, the heat applied is sufficient to at least soften the adhesive backing 201. The softened adhesive backing 201 can be adhered to the woven textile 103 with or without the application of pressure. In some configurations, the pressure is sufficient to at least sufficiently mechanically interlock the softened adhesive backing 201 with the woven textile 103. The temperature required to soften the adhesive backing 201 depends on the chemical properties of the adhesive. It can be appreciated that, when adhesive backing 201 is a thermosetting adhesive, the lamination step 107 can A-, B- and/or C-stage the adhesive backing 201. A- and/or B-staging of adhesive backing 201 is generally preferred when the adhesive 201 is to be subsequently adhered to another material, though the adhesive backing 201 can be C-staged and later contacted with a hot melt or other thermoplastic adhesive to adhesively contact and/or bond the woven textile 103 to a substrate.

The lamination step 107 substantially secures the woven textile 103 to the adhesive backing 201. The adhesive backing 201 provides stability to the first assembly 101, the stability preferably keeps the first assembly 101 substantially flat. Without the adhesive backing 201 woven textile 103 can lack sufficient stability. Furthermore, the woven textile 103 lacking the adhesive backing 201 can be difficult to keep flat and stable enough to align the graphic design image 215 in registration for further processing, such as, cutting. The backing adhesive 201 can provide sufficient stability and/or rigidity to the first assembly 101 to allow the first assembly 101 to be aligned for further processing. Preferably, the first assembly 101 is sufficiently rigid to be aligned for cutting. More preferably, the first assembly 101 is sufficiently rigid to be aligned for cutting and/or processing on a machine. The woven textile 103 lacking the backing adhesive 201, due to insufficient stability and/or rigidity, requires manual alignment. Furthermore, the backing adhesive 201 can maintain the woven textile 103 in a substantially wrinkle-free condition. Moreover, the backing adhesive 201 can maintain the woven textile 103 in a substantially flat wrinkle-free condition after the woven textile 103 has been laundered.

The stability of the woven textile 103 can be affected by thermally induced shrinkage of the woven textile 103. The woven textile 103 shrinkage can depend upon the amount of heat applied to the woven textile 103. More specifically, the greater the amount of heat applied and/or the greater the temperature attained by the woven textile 103, the greater the degree of shrinkage of the woven textile 103.

In one preferred embodiment, the woven textile 103 is pre-shrunk prior to contacting the woven textile with the backing adhesive 201. In one configuration, the woven textile 103 can be pre-shrunk, with the amount of shrinkage being dependent upon the thermally induced maximum temperature attained by the woven textile 103. For thermally induced shrinkage, the woven textile 103 is heated to a selected temperature for a period of time and after the period of time the heated woven textile is cooled. The woven textile 103 weave can relax during the cooling process. After the weave relaxes, the adhesive backing 201 can be applied to the woven textile 103. The selected temperature is at least greater than the maximum temperature attained during the lamination step 107 and/or the maximum temperature attained during the method 100. For example, when the maximum temperature is experienced during the lamination step 107, the selected temperature is at least greater than the maximum temperature of the lamination step 107. While not wanting to be bound by any theory, the woven textile 103 can shrink when heated to the selected temperature and cooled. The woven textile 103 can shrink by as much as 20% or more, depending on the selected temperature.

In another configuration, the pressure applied to the woven web during the lamination step 107 is sufficiently large to substantially inhibit shrinkage of the woven textile 103. Preferably, the applied pressure is at least about 1 psi, more preferably at least about 10 psi, and even more preferably at least about 12 psi. In one embodiment, the applied pressure is about 12 psi to about 50 psi. In one configuration, the pressure applied during lamination step 107 by a platen to the woven textile 103 is preferably at least about 1 psi and even more preferably at least about 1.4 psi. Commonly, the total applied pressure is at most about 8.5 lbs, even more commonly at most about 8.0 lbs, and even more commonly at most about 7.5 lbs. Under the applied pressure, one or more dimensions of the woven textile 103 can shrink (that is, decrease) no more than about 5%. Preferably, at least each of the one or more dimensions of the woven textile 103 can shrink (that is, decrease) no more than about 2.5%. After lamination, the adhesive backing 201 maintains substantially the dimensions of the woven textile 103 and design image 215.

Regarding the graphic image 215, the graphic image 215 can be sublimation printed during the lamination process or can be sublimation printed after the lamination process. In one configuration, the woven textile 103 can be provided with the graphic image 215. In another configuration, the woven textile 103 can be provided without the graphic image 215.

In step 109, the first assembly 101 can be cut to form a woven textile design 111 having one or more woven textile design cut edges. The one or more woven textile design cut edges comprise a plurality of cut fiber ends. The first assembly 101 can be cut in registration with the graphic design image 215. The cutting process can be by any cutting process. Preferably, the cutting process comprises a laser or a die cutting process. The cutting process can also include an ablation process to improve adhesion of the woven textile 103 in subsequent processing. Particularly preferred laser cutting and/or ablation processes are disclosed in U.S. application Ser. No. 11/874,146 with a filing date of Oct. 17, 2007, to Abrams, which is incorporated herein in its entirety with this reference.

A laser cutting process is preferred. The laser cutting process can seal and/or fuse the one or more woven textile design cut edges. That is, the laser cutting process can seal and/or fuse at least some, if not all, of the plurality of cut fiber ends comprising each and/or all of the one or more woven textile design cut edges. The sealed and/or fused one or more woven textile design cut edges can extend the useful area of the woven textile design 111. Furthermore, the fibers comprising the sealed and/or fused one or more woven textile design cut edges do not “pop-up” or fray, as do the fibers comprising die-cut yarn edges. Die-cut edges can have long loose “float” yarns on the surface which “pop up” and are easily and quickly frayed. The fibers comprising the sealed and/or fused one or more woven textile design edges can stay-in place and can be more durable. Such sealed woven textile design edges are more highly valued by consumers. The fused-edges of the woven textile design 111 can also allow of higher processing line speeds. While not wanting to be bound by any theory, the backing adhesive 201 and the fibers comprising the one or more sealed woven textile design edges can fuse together during the laser cutting process to form the sealed woven textile design edges. The sealed woven textile design edges can have a “beaded-like” appearance and/or shape. It can be appreciated that, for some applications and/or designs frayed edges can be preferred. Such as, designs having a worn, more casual, or more vogue appearance.

The degree the fibers of the woven textile design edges fuse together can be determined by laser power and/or cutting speed. For example, low laser power and/or fast cutting speed can decrease the degree to which the cut-edge is fused. Optimal sealed and/or fused woven textile design edges can require balancing of the laser power and/or line speed to properly fuse most, if not all, of the fibers comprising the woven textile design edge.

In one implementation, a cutting machine performs the cutting process 109. The cutting machine can have an optical element for identifying one or more selected reference points on the first assembly 101. The one or more reference points can be identified optically. The optical identification can be by a conventional laser light registration system, such optical identification processes are known by those of skill in the art. An optical registration process is preferred over a machine guide side process. After identifying the one or more selected reference points, the optical identification cutting process can use programmed logic to impart a precise registration prior to and/or during the cutting process. Preferably, the first assembly 101 is cut to a desired size and/or shape to match a void opening in the flocked transfer 601. In other configurations, the graphic design image 215 of the textile design 111 is registered relative to the flock transfer.

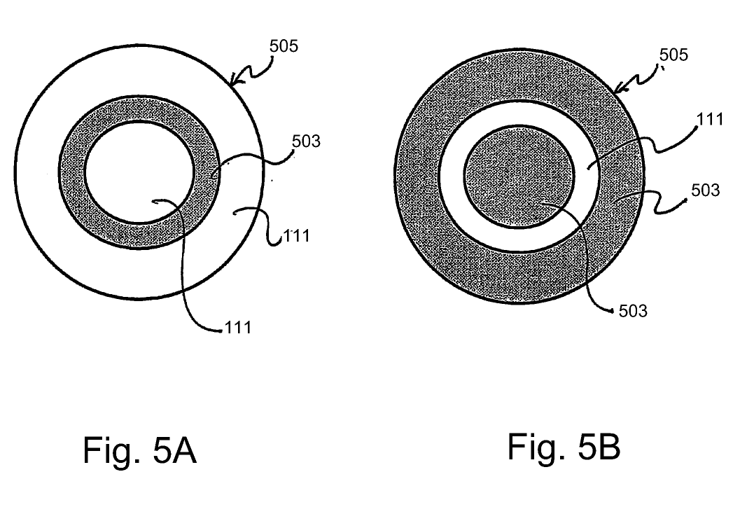

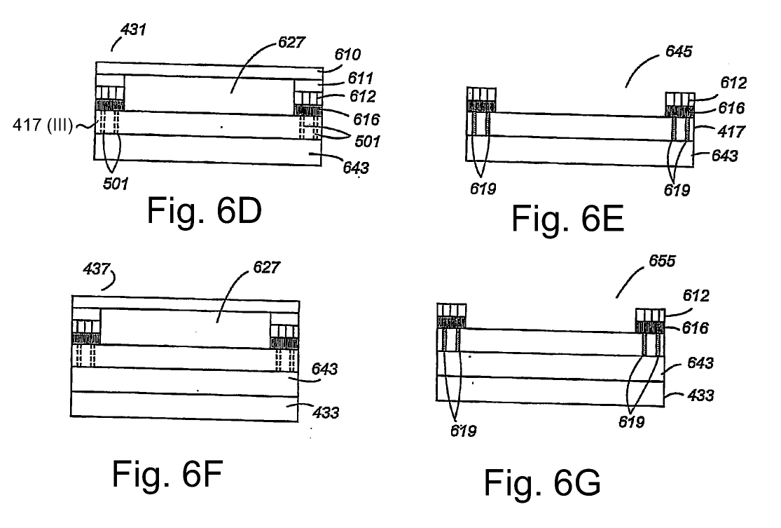

FIG. 4 depicts method 400 for making a flocked article compositing the woven textile 103. More specifically, method 400 depicts a method for adhering the textile design 111, provided in step 417, to a flocked transfer 601 (FIGS. 6A-6G). The textile design 111 may or may not be laser, mechanically, chemically, or thermally treated to improve bonding adhesion to an adhesive 616. That is, at least some of the woven textile 103 can be treated mechanically, chemically, thermally, or with a laser in selected areas to from a contact area 629. While not wanting to be bound by theory, the contact area 629 can provide for enhanced adhesion by one or more of the following: mechanical interlocking, and chemical and physical adhesive bonding by one or more of: chemisorption, dispersive interactions, electrostatic interactions, and diffusion. In one configuration, the textile design 111 is treated, such as, but not limited to laser ablation process, to form the contact area 629. Preferably, the contact area 629 comprises a plurality of holes 501. In some configurations, the plurality of holes 501 can extend entirely through the textile design 111 (that is, through woven textile 103 and adhesive 201) to better facilitate adhesion. The contact area 629 and/or the plurality of holes 501 can be formed according to U.S. patent application Ser. No. 11/874,146 with a filing date of Oct. 17, 2007, and U.S. patent application Ser. No. 12/031,445 with a filing date of Feb. 14, 2008, each of which is incorporated in its entirety herein by this reference.

In step 419, the flocked transfer 601 (FIG. 6A) is provided. The flocked transfer 601 can comprise a release sheet 610, release adhesive 611, plurality of flock fibers 612, and void 627. The flock fibers have opposing first and second ends. The first ends of the flock fibers are adhered to the release sheet 610 by the release adhesive 611. The flocked transfer 601 can also be manufactured as taught by U.S. Pat. Nos. 5,207,851 and/or 5,346,746, which are incorporated in their entirety herein by this reference.

One or both of the void 627 and embossed textile design 111 can be configured and/or sized, such that the textile design 111 and void 627 substantially match to properly display the textile design 111, when the textile design 111 is placed adjacent to the void 627. In one configuration, when the textile design 111 is placed adjacent to the void 627, at least one of the void 627 and/or the graphic design image 215 substantially match in size and/or shape to properly display the textile design 111 and/or graphic image 215.

In another configuration, the graphic design image 215 and/or textile design 111 are slightly larger than the void 627. In this configuration, one or more dimensions of the design image 215 and/or textile design 111 can be at least about 2 mm larger than the corresponding dimension of the void 627. More preferably, the one or more dimensions of the design image 215 can be at least about 4 mm larger than the corresponding dimension of the void 627.

Returning to the flocked transfer 601, the plurality of flock fibers 612 can comprise any flock fibers. Particularly preferred are spun-dyed flock fibers having a color dye and/or pigment within the flock fibers. Typically, the dye and/or pigment are added to a polymer melt before and/or during the spinning of the flock fibers. The dye and/or pigment can be contained and/or entrapped within the polymer comprising the flock fibers. The spun-dyed flock fibers are commonly known as color-fast flock fibers, that is, the dye or pigment is substantially retained within the flock fibers and is substantially resistant to fading, bleaching, or bleeding when laundered. Spun-dyed flock is especially resistant to high temperature, high pH industrial laundering processes. Another preferred flock dyeing process is high temperature and pressure autoclave dyeing. Flock fibers prepared by the autoclave dye process also substantially withstand industrial laundering.

In step 421, an adhesive 616 is applied to least some of the plurality of flock fibers 612 second ends. The adhesive 616 can be any adhesive. Preferably, the adhesive 616 is a thermosetting or thermoplastic adhesive as described above. The adhesive 616 can be a liquid, powder, web, paste, or solid adhesive. When the adhesive 616 is a liquid, it can be sprayed, wet coated, or screen-printed on the second ends of the flock fibers 612. When the adhesive 616 is a solid, it can be one of a powder, web, or dry self-supporting film, such as, as a continuous extruded film. In a practically preferred embodiment, the adhesive 616 is a polyester or nylon adhesive. In particularly preferred embodiment, the adhesive 616 is a paste adhesive as described above. Preferably, the adhesive 616 is applied to at least some of the plurality of flock fiber second ends by a screen printing process. More preferably, the adhesive 616 is a paste adhesive screen printed on at least some of the plurality of flock fiber second ends.

In step 423, the textile design 111 and the flocked transfer 601 with the adhesive 616 are contacted in registration. The textile design 111 and the adhesive 616 are contacted in registration, such that at least most, if not all, of the contact area 629 is contacted in registration with the adhesive 616. Furthermore, the void 627 is in registration with at least most, if not all, of the graphic design image 215 of the textile design 111.

In step 425, the adhesive 616 is thermally bonded to the textile design 111 to form first product 427 (FIG. 6B). During lamination step 425, the adhesive 616 can be softened and/or partly liquefied and under the application of heat and pressure the adhesive 616 can flow into and/or substantially over the contact area 629. In one configuration, the softened and/or partly liquefied adhesive can flow into the plurality of holes 501 filing the plurality of holes 501 with adhesive 616 (shown in FIG. 6B as 619).

In one configuration, the adhesive 616 can hold the flocked transfer 601 to the woven textile design 111 (FIGS. 6A-C) with a sufficiently strong bond strength. In one particular configuration, the adhesive 616 held the flocked transfer 601 to the woven textile design 111 with an adhesive bond strength, as measured with a laboratory peel tester, of at least about 10 pounds. While not wanting to be bound by any theory, the woven textile design 111 is primarily secured to the adhesive 616 by a mechanical inaction of the adhesive 616 and the woven textile design 111. More specifically, the woven textile design 111 is primarily secured to the adhesive 616 by a mechanical interaction of the contact area 629 and the adhesive 616. That is, one of a molten holtmelt thermoplastic adhesive (e.g., LextraPrint®), a thermoplastic film (LextraMax®), or a paste adhesive penetrates and/or mechanically intersects with the contact area 629. Preferably, the adhesive 616 penetrates and/or surrounds the fibers within the contact area 629 of the woven textile 111. More specifically, the adhesive 616 penetrates and/or interacts with the fibers within at least the contact area 629 when in the softened state (such as, a partially softened and liquefied state), followed by one or both of cooling and solidifying. The cooled and/or solidified adhesive 616 penetrated within and/or surrounded around the fibers within the contact area 629 of woven textile 111 provides for a substantially strong adhesion interaction.

In optional step 429, an adhesive backing 643 (FIG. 6D) is applied to surface 225 (FIG. 2) of adhesive 201. The adhesive backing 643 can be any adhesive as described above, preferably, a liquid, web paste, or solid form of one of a thermosetting, thermoplastic, or multi-component adhesive thereof. Preferably, backing adhesive 643 is one of a solid web, dry self-supporting film (such as, as a continuous extruded film), a multi-component adhesive film (such as, a bi-component adhesive film) or a paste adhesive as described above. In one embodiment, the adhesive 643 can be a polyester, nylon, or polyurethane adhesive. In another embodiment, the preferred backing adhesive 643 is a thermoplastic adhesive, preferably a soft rubber-like polyurethane, and more preferably a very soft, rubber-like polyurethane. Preferably, the backing adhesive 643 can be a non-woven web adhesive, more preferably a thermoplastic, no-woven web adhesive. Preferably, the web adhesive is one of a polyester, polyamide, polyolefin, or combination thereof. The web adhesive can be contacted with surface 225. In some configurations, a thermoplastic polyurethane adhesive layer can be interposed between surface 225 and the web adhesive. In such a case, the backing adhesive 643 comprises a bi-component adhesive of the thermoplastic polyurethane and web adhesives. While not wanting to be bound by any theory, the thermoplastic polyurethane provides the unexpected advantage of keeping the thermoplastic web adhesive from flowing through the thermosetting adhesive 201 in certain instances. In yet another embodiment, the adhesive backing 643 is thermoplastic adhesive of about at most 1 mil thickness.

In a particularly preferred embodiment, the backing adhesive 643 comprises an aqueous paste adhesive. More preferably, the backing adhesive 643 comprises an aqueous polyester paste adhesive.

In another embodiment, the backing adhesive 643 is a foamable or foaming thermosetting adhesive. That is, the backing adhesive 643 includes one or more foaming agents selected such that, when step 435 is performed, the backing adhesive 643 is simultaneously foamed. The foamed adhesive will expand into the voids created by the embossed design, thereby providing a relatively level lower backing adhesive 643 surface.

Returning to optional step 429, the backing adhesive 643 is contacted with the surface 225, and laminated with sufficient pressure and heat to cause the backing adhesive 643 to substantially flow. In can be appreciated that, the temperature and pressure required for the backing adhesive 643 to substantially flow depends on the chemical and physical properties of the backing adhesive 643. During lamination, the backing adhesive 643 can flow into the plurality of holes 501, the adhesive filling the plurality of holes 501, providing adhesion of the backing adhesive 643 to the thermosetting adhesive 201 of textile design 111 to form a second product 431 (FIG. 6D).

The release sheet 610 along with the associated release adhesive 611 (if still attached) can be peeled from the second product 431 to form another flocked product 645 (FIG. 6E) having a woven textile insert, which can, for example, be applied to a garment, other textile item, or other non-textile surface by sufficient heat and pressure to adhere (and/or bind) the adhesive backing 643.

In step 435, a substrate 433 is provided and contacted with the second product 431. The substrate 433 can be substantially any hard or soft material that a thermoplastic adhesive can sufficiently adhere to. The substrate 433 can be, but is not limited, to any textile product, apparel (textile or non-textile), and/or consumer product (such as, automotive, electronic, computer, soft or hard goods, etc.). After and/or substantially simultaneous with contacting the second product 645 with the substrate 433, one or both of heat and pressure can be applied. The applying of one or both of heat and/or pressure can be substantially sufficient to activate the adhesive backing 643 to adhere the second product 645 to the substrate 433 to form a third product 437 (FIG. 6F). After adhering the second product 645 to substrate 433, the release sheet 610 and release adhesive 611 (if still attached) can be removed to form yet another flocked product 655 (FIG. 6G).

In one embodiment, steps 423 and 425 can be preformed substantially simultaneously to form the first product 427. Similarly, in another embodiment, steps 423, 425, and 429 can be preformed substantially simultaneously to form the second product 431. And, in yet another embodiment, steps 423, 425, 429, 433, and 435 can be preformed substantially simultaneously to form the third product 437. It can be further appreciated, that steps 429, 433, and 435 can be substantially preformed when the first product 427 is provided to form the third product 437.

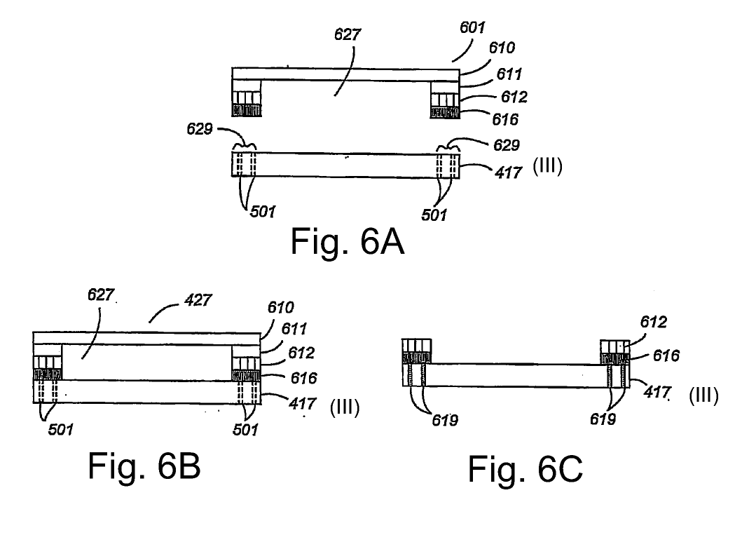

FIG. 5A depicts an embodiment having a textile design 111 insert, a flock surface 503 surrounding and/or defining the shape of the textile design 111, and having an outer most perimeter 505 comprising in part the textile design 111. It can be appreciated that, the outer most perimeter 505 edge of the textile design 111 comprises a heat sealed and/or fussed edge. The woven textile 103 heat sealed and/or fussed edge being sufficiently fused to substantially prevent any fraying and/or unraveling of the woven textile 103 weave. It can further be appreciated that, while FIGS. 6A-G depict the flock fibers 612 applied at and/or near the edge and/or perimeter of the textile design 111, the flock fibers 612 can be applied anywhere on textile design 111.

FIG. 5B depicts another embodiment having a flock surface 503 surrounded by a textile design 111, and an outer most perimeter 505 comprising in part the flock surface 503.

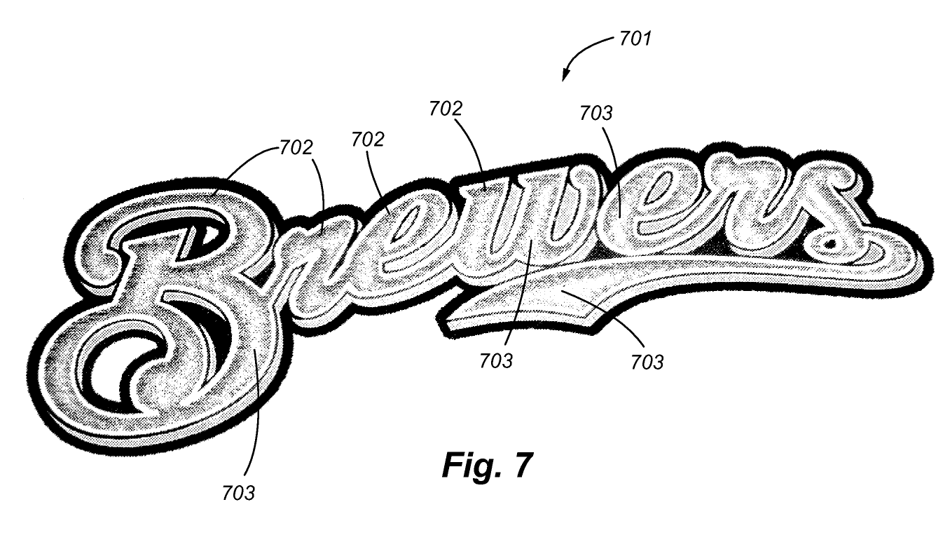

FIG. 7 depicts a woven textile appliqué 701 comprising dyeable and non-dyeable yarns. The non-dyeable yarn regions 702 can have a greater luster than the dyeable yarn regions 702. The greater luster regions 703 impart one or more of a shinny, specularly, sparkly aspects and beauty to the woven textile appliqué 701 previously unachievable in woven textile appliqués.

In one embodiment, an optional sublimation dye step (not depicted in FIG. 4) can be included during lamination step 425 or contact lamination step 435. In another embodiment, an optional sublimation dye step (not depicted in FIG. 4) can be included before or after lamination step 425 or contact lamination step 435.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A textile design, comprising:
(a) a woven textile having:
dyeable and non-dyeable fibers, and
having first and second opposing sides,; and
(b) an adhesive, wherein the adhesive is positioned on the second side.
